(19) United States
(12) Patent Application Publication
(10) Pub. No.: US 2010/0285822 A1
(43) Pub. Date: Nov. 11, 2010

(54) NEXT GENERATION OF MARKETING AND METHOD

(76) Inventor: Conrad R. Carney, II, Lexington, KY (US)

Correspondence Address: KING & SCHICKLI, PLLC, 247 NORTH BROADWAY, LEXINGTON, KY, 40507, US

(21) Appl. No.: 12/774,211

(22) Filed: May 5, 2010

Related U.S. Application Data
(60) Provisional application No. 61/175,688, filed on May 5, 2009.

(51) Int. Cl. H04W 4/14

(52) U.S. Cl. 455/466

(57) ABSTRACT

A method of marketing includes steps of providing a business with a mobile phone text messaging service, providing a medium for a customer to join that text messaging service, creating and maintaining a list of customers for the business and sending a communication to at least one of the customers.

This application claims priority to U.S. Provisional Patent Application Ser. No. 61/175,688 filed 5 May 2009, the entire disclosure of which is incorporated herein by reference.

### TECHNICAL FIELD AND INDUSTRIAL APPLICABILITY OF THE INVENTION

The present invention relates generally to the marketing field and, more particularly, to a method of marketing utilizing mobile phone text messaging.

### BACKGROUND OF THE INVENTION

The marketing of goods and services by means of mobile phone text messaging is a rapidly growing field. The concept of narrow casting text messages to existing or potential business customers is known. Relevant prior art patents include U.S. Pat. No. 6,754,314 to Wengrovitz et al, U.S. Pat. No. 7,197,324 to Sweeney and U.S. Pat. No. 7,437,413 to Okuyama et al.

The present invention relates to a new and improved method of marketing using a mobile phone text messaging service.

### SUMMARY OF THE INVENTION

In accordance with the purposes of the present invention as described herein, a method of marketing comprises the steps of providing a business with a mobile phone text messaging service, providing a medium for a business customer or potential customer to join the text message service, creating and maintaining a list of customers for the business and sending a communication to at least one of the customers. That communication is selected from a group consisting of a product discount, a service discount, a coupon, an appointment reminder, product information, service information or a combination thereof.

In the following description there is shown and described several different embodiments of the invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated herein and forming a part of the specification, illustrate several aspects of the present invention and together with the description serve to explain certain principles of the invention. In the drawings:

FIG. 1 is a schematical block diagram illustrating the system and method of the present invention.

Reference will now be made in detail to the present preferred embodiment of the invention, examples of which are illustrated in the accompanying drawings.

### DETAILED DESCRIPTION OF THE PREFERRED EMBODIMENTS OF THE INVENTION

The present invention relates to a method of marketing that may be broadly described as comprising the steps of: (a) providing a business with a mobile phone text messaging service; (b) providing a medium for an existing customer or a potential customer to join that text messaging service; (c) creating and maintaining a list of customers for that business; and (d) sending a communication to at least one of the customers. That communication is selected from a group consisting of a product discount, a service discount, a coupon, an appointment reminder, product information, service information or a combination thereof.

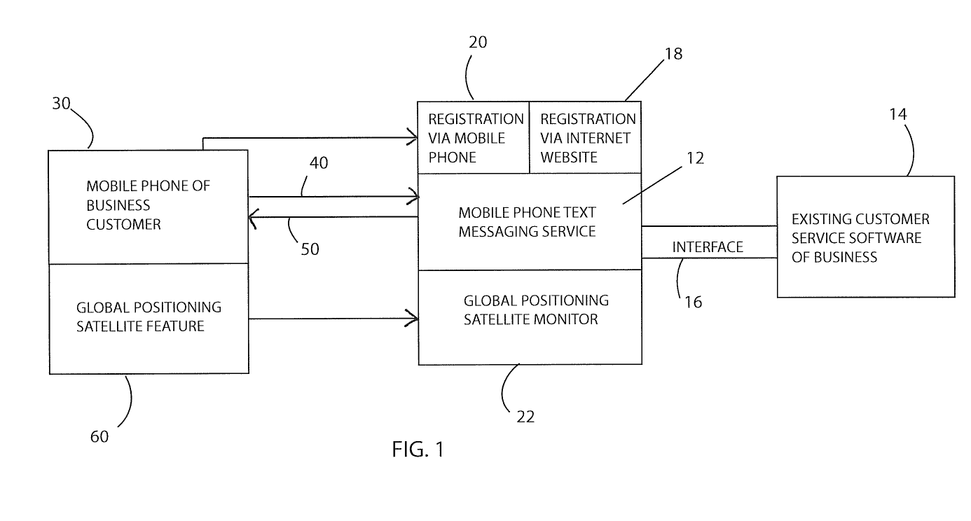

As illustrated in FIG. 1, the system 10 utilized to establish the method of marketing includes a mobile phone text messaging service 12. Preferably, as illustrated in FIG. 1, that mobile phone text messaging service 12 is connected to an existing customer service software of a business 14 desiring text messaging services by means of an interface 16.

It should also be appreciated that the mobile phone text messaging service 12 is a permission based service requiring the registration of a customer or potential customer of the business. Two mediums are provided for a customer to join the text messaging service 12. The first provides for customer registration via an internet website 18. The second provides for customer registration via mobile phone texting 20. Thus, a potential customer or existing customer uses his mobile phone 30 to register via the cell phone registration medium 20.

To register, a customer provides personal data which is stored in memory. That data includes but may not necessarily be limited to residence information including address and mobile phone number. The individual registering may then review a list of businesses represented by the text messaging service 12. The individual then selects those businesses from which it is desired to receive discounts, coupons and other communication. This activates text messaging services with that business.

All business customers are then maintained on a list. The system also provides the business with an indication of how many times a particular individual or customer has taken advantage of a coupon or special offer sent by text message. Thus, the list represents valuable marketing information stored with the text messaging service. This greatly increases the value of the service 12 and provides the business with an incentive to maintain the service.

Once an individual customer or potential customer is registered for the service, the mobile phone text messaging service 12 sends a communication (note action arrow 40) to the mobile phone of the individual. That communication may, for example, include a discount offer for a product or service of the business or businesses for which the customer has “activated” the service. The individual may then use his mobile phone to text a reply to the mobile phone text messaging service 12(note action arrow 50) accepting the offer. The mobile phone text messaging service 12 may then send a discount coupon to the individual's mobile phone 30 (note action arrow 40).

In accordance with an additional significant aspect of the present invention, the system may include a global positioning satellite monitor 22. The global positioning satellite, or GPS, monitor 22 locates the individual customer or potential customer by monitoring the global positioning satellite, or GPS, feature 60 of the mobile phone 30 carried by the individual. Once the individual reaches an identified or pre-selected location the mobile phone text messaging service 12 sends a communication to the individual specific for the identified location. In one particularly useful embodiment of the present invention the individual customer or potential customer may preselect one or more businesses allowed to send a communication to the customer's mobile phone 30 when it is detected in the identified location. Thus, the individual may go to the registration website 18 and choose to activate the GPS monitoring service option. The individual also selects the businesses or vendors who will be authorized to send messages to the mobile phone 30 of the individual when the phone is detected in the selected pre-determined or designated location.

Once the individual travels to the pre-selected location, the global positioning satellite monitor 22 detects the presence of the individual's phone 30 at the location. This prompts the mobile phone text messaging service to send an appropriate pre-authorized communication from the designated or selected vendors/businesses to the individual's phone 30. Such a communication may, for example be coupons, discounts or incentives that are specific to the users current location such as, for example, discounts for museum tickets, directions to a selected restaurant or any other information desired by the individual. Stated another way, the location of the individual is pinpointed using the global positioning satellite feature 60 of the individual's phone 30 and appropriate coupons or other communication are sent to that cell phone based on the vendor/businesses previously authorized to do so by the individual. Thus, the marketing provided by the text messaging service 12 is targeted, more efficient and more effective.

The interface 16 with the existing customer service software of the business 14 is particularly useful for reminding and confirming customer/client appointment times while providing important business related notices. In one particularly useful embodiment the business is a medical practice or a dental practice having an existing software system for maintaining appointment schedules. The existing appointment software is integrated into the text message platform by the interface 16. The office staff enters a patient appointment into the existing appointment software and that appointment is then interfaced into the text message platform. At the appropriate date and time an appointment reminder message will be sent to the individual from the mobile phone text messaging service 12 to the mobile phone 30 of the customer, client or patient. For example, an appointment reminder message may be sent both twenty-four hours and one hour before the actual appointment. Such reminders reduce the number of appointments missed by customers/clients/patients thereby increasing the efficiency and profitability of the business.

Similarly, in another useful embodiment the business is a bank having an existing bank software for billing reminders, late notices, overdraft notices, marketing messages and other communications. In this situation the mobile phone text messaging service 12 is connected to that existing software 14 via the interface 16 so that billing reminders, late notices, overdraft notices, marketing messages and other communications of importance to the individual may be communicated through the mobile phone text messaging service 12 to the mobile phone 30 of the customer where it can be promptly read by the customer. This is true even when the customer is traveling and isolated from hard mail service or internet connection.

The foregoing description of the preferred embodiments of the present invention have been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed:

1. A method of marketing, comprising:
providing a business with a mobile phone text messaging service;
providing a medium for a customer to join said text messaging service;
creating and maintaining a list of customers for said business;
sending a communication to at least one of said customers wherein said communication is selected from a group consisting of a product discount, a service discount, a coupon, an appointment reminder, product information, service information or a combination thereof.

2. The method of claim 1, including:
locating at least one of said customers using a global positioning satellite feature of said mobile phone carried by said at least one customer; and
sending a communication to said at least one customer specific for an identified location of said at least one customer.

3. The method of claim 2, wherein said at least one customer preselects a business allowed to send a communication to said at least one customer's mobile phone when detected in said identified location.

4. The method of claim 1, including interfacing said mobile phone text messaging service with existing customer service software of said business.

5. The method of claim 1, wherein said business is a medical practice or a dental practice having an existing appointment software and said method includes interfacing said mobile phone text messaging service with said existing appointment software.

6. The method of claim 5, including sending at least one of said customers an appointment reminder.

7. The method of claim 6, including sending appointment reminders 24 hours and one hour before said appointment.

8. The method of claim 1, wherein said business is a bank having an existing bank software for billing reminders, late notices, overdraft notices, marketing messages and other communications and said method includes interfacing said mobile phone text messaging service with said existing bank software.

9. The method of claim 1, wherein said medium is an internet website.

10. The method of claim 1, wherein said medium is a mobile telephone number.
